(19) United States
(12) Patent Application Publication
(10) Pub. No.: US 2010/0192089 A1
(43) Pub. Date: Jul. 29, 2010

(54) CONTROLLING SCROLLING OF A DOCUMENT

(75) Inventors: Xiao He, Beijing (CN); Yue Ma, Beijing (CN); Wei She, Beijing (CN); Pei Ling Zhou, Beijing (CN); Zhi Bo Zuo, Beijing (CN)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: International Business Machines Corporation, Armonk, NY (US)

(21) Appl. No.: 12/691,373

(22) Filed: Jan. 21, 2010

(30) Foreign Application Priority Data
Jan. 23, 2009 (CN) 200910002998.8

(51) Int. Cl. G06F 3/048

(52) U.S. Cl. 715/784

(57) ABSTRACT

Provided are a method and device for controlling scrolling of a document, the document has a marked section and is scrolling-displayed within a display area, and the method comprises detecting whether the document is scrolled to the marked section, and restricting the scrolling of the document when the document is scrolled to the marked section. The method and device can control the scrolling of the document according to contents of the document, so that the contents cannot be neglected due to quick scrolling of the document.

### CROSS-REFERENCE TO RELATED APPLICATIONS

This application claims priority under 35 U.S.C. §119(a) to Chinese Patent Application Serial Number 200910002998.8, filed Jan. 23, 2009, entitled “A New Approach for Specified Information Highlighting and Orientation”, the entirety of which is incorporated herein by reference.

### FIELD OF THE INVENTION

The present invention relates to a method and device for controlling scrolling of a document, and in particular to a method and device for controlling scrolling of a document based on contents of the document.

### DESCRIPTION OF RELATED ART

When people read a long document on a screen of a computer, they have to scroll the document, in other words, scroll the screen, so as to read the whole document, because the whole document cannot be displayed at a time. At present, a scroll bar is used to control scrolling of documents. The scrolling of documents can be controlled in two ways of manual scrolling and automatic scrolling. For example, the manual scrolling of documents can be achieved by dragging the scroll bar with a mouse, rotating a wheel of the mouse, sliding a finger on a touch panel of a notebook computer, or in other ways. The automatic scrolling of documents can be achieved by pressing a wheel button of the mouse.

However, scrolling of a document cannot be controlled according to contents of the document in existing methods. In particular, when creating a document, such as a web page, a WORD document, a PDF document, or the like, creators often hope that some contents can be noticed by a reader without being neglected intentionally or unconsciously due to quick scrolling of the document, and sometimes, they often hope that a time control can be applied to these contents to ensure that the reader can adequately notice and read these contents. For example, in one scenario, web page content providers or advertisers sometimes hope to draw attention of a reader to specific contents on a web page, such as advertisements; however, although currently this can be achieved by displaying these contents in a more striking manner, the reader may easily neglect the specific contents by quickly scrolling the web page. In another scenario, when a user browses a PDF document having a plurality of chapters, he sometimes hopes to scroll the document quickly to a chapter which he must read without omitting the chapter due to quick scrolling, or hopes to scroll the document quickly to the beginning of each chapter to see whether contents of the chapter is important; however, currently there is no appropriate method for controlling the scrolling of the document to meet the requirement of the user.

### SUMMARY OF THE INVENTION

According to an aspect of the present invention, there is provided a method for controlling scrolling of a document, the document has a marked section and is scrolling-displayed within a display area, and the method comprises detecting whether the document is scrolled to the marked section, and restricting the scrolling of the document when the document is scrolled to the marked section.

According to another aspect of the present invention, there is provided a device for controlling scrolling of a document, the document has a marked section and is scrolling-displayed within a display area, and the device comprises a detecting unit for detecting whether the document is scrolled to the marked section, and a controlling unit for restricting the scrolling of the document when the document is scrolled to the marked section.

The method and device for controlling scrolling of a document according to the above aspects of the present invention can restrict the scrolling of the document when the document is scrolled to a marked section including contents specified in advance by a user, so that the contents will not be neglected due to quick scrolling.

### BRIEF DESCRIPTION OF THE DRAWINGS

The above and other objects, features, and advantages of the present invention will become more apparent from the detailed description of embodiments of the present invention in conjunction with the attached drawings, in which:

FIG. 1 is a diagram schematically showing marked sections in a document;

FIG. 2 is a flow diagram showing a method for controlling scrolling of a document according to a first embodiment of the present invention;

FIG. 3 is an exemplary flow diagram for explaining step S203 shown in FIG. 2;

FIG. 4 is a schematic diagram for explaining position relationship of a document, a display area, and a marked section;

FIG. 5 is a flow diagram for explaining step S204 shown in FIG. 2;

FIG. 6 is a block diagram showing a device for controlling scrolling of a document according to the first embodiment of the present invention;

FIG. 7 is a flow diagram showing a method for controlling scrolling of a document according to a second embodiment of the present invention; and

FIG. 8 is a block diagram showing a device for controlling scrolling of a document according to the second embodiment of the present invention.

### DETAILED DESCRIPTION OF THE INVENTION

A method and device for controlling scrolling of a document according to embodiments of the present invention will be described below with reference to the accompanying drawings. Throughout the drawings, like reference signs represent similar elements. It is to be understood that the embodiments described herein are only illustrative, and should not be construed to limit the scope of the invention.

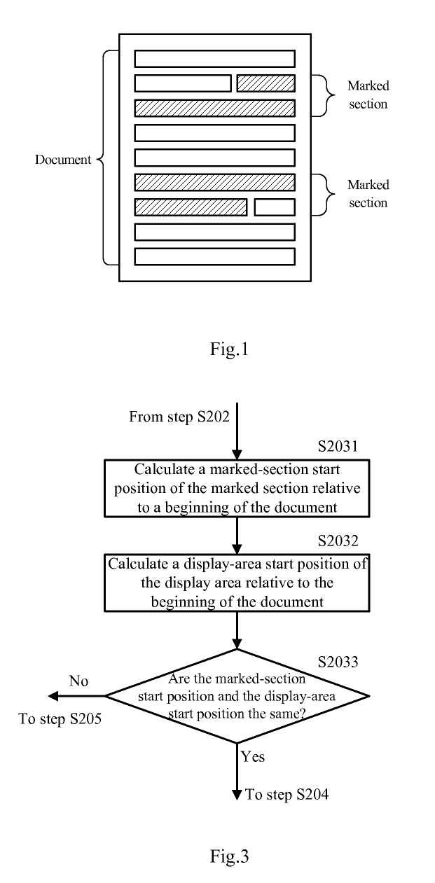

As described above, a creator of a document may hope that some contents in the document can be noticed by a reader when the document is scrolled without being neglected due to quick scrolling of the document. Further, the reader of the document may also hope that some contents in the document can be easily located. The document may be a web page, a WORD document, a PDF document, or a document in other formats. To this end, the creator or the reader may mark these desired contents in the document to generate one or more marked sections including these desired contents, and control the scrolling of the document according to the marked sections. FIG. 1 schematically shows marked sections (as shown by hatched parts) in a document.

A plurality of methods can be employed to mark the desired contents in the document. Moreover, the desired contents in the document may be marked by the creator of the document when the document is created, and the desired contents in the document may also be marked by the reader of the document by, for example, editing a script file for the document, after the creation of the document is completed.

For the convenience of explanation, a Hypertext Markup Language (HTML) web page is taken as an example. As is well known, a tag “div” is included in a HTML script file for the web page. The creator or the reader may add a new attribute “section” into the tag “div” containing desired contents, so as to use the attribute “section” as a mark to mark the desired contents as a marked section, and may set a restriction time period for restricting scrolling of the document when the document is scrolled to the marked section by setting a value of the attribute “section”, as exemplarily shown by the following codes.

<html>

<body>

<div section=“5”>

desired contents

</div>

</body>

</html>

In this example, the desired contents to which the attribute “section” is added become the marked section, and since the value of the attribute “section” is set to 5, the scrolling of the document will be restricted for 5 seconds when the document is scrolled to the marked section. The restriction time period can be changed by changing the value of the attribute “section”. It is to be noted that, if the value of the attribute “section” is set to 0, the scrolling of the document will be restricted for a very short time period which is preferably less than 1 second, for example, 0.5 second, when the document is scrolled to the marked section. In a variant, if the value of the attribute “section” is set to 0, the scrolling of the document may not be restricted when the document is scrolled to the marked section.

For other types of documents, a mark may be similarly added to desired contents according to characteristics of the documents and corresponding document readers, so as to mark the desired contents as a marked section, and a restriction time period for restricting scrolling of the documents when the documents are scrolled to the marked section may be specified using a value of the mark. For example, a similar eXtensible Markup Language (XML) attribute may be added to desired contents in a WORD document, so as to use the attribute as a mark to mark the desired contents as the marked section, and use a value of the attribute to specify the restriction time period. It is to be noted that, the added mark only works for document readers supporting the method for controlling scrolling of a document according to embodiments of the present invention, such as, web browsers, Microsoft® WORD® software, Adobe® Acrobat Reader®, and the like, and for document readers which do not support the method, the added mark will be automatically omitted and will not be identified.

For a document including the above-described marked section, the method and device according to embodiments of the present invention can identify the marked section, and control scrolling of the document according to the marked section, so as to avoid the contents in the marked section from being neglected due to quick scrolling of the document.

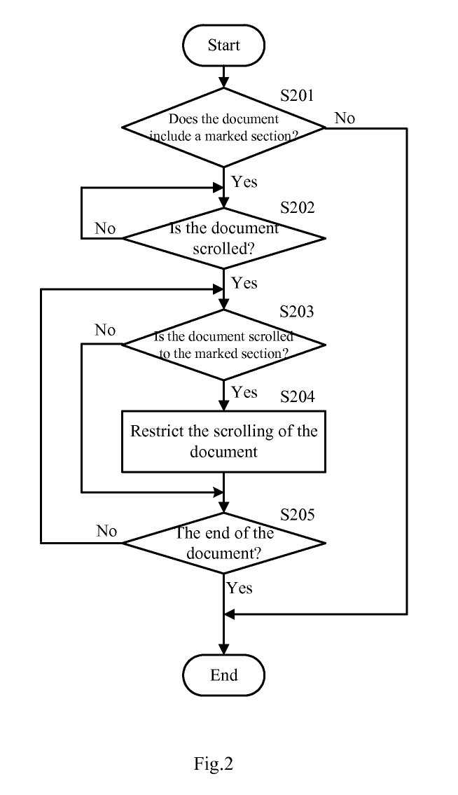

Hereinafter, a method for controlling scrolling of a document according to the first embodiment of the present invention will be described with reference to FIG. 2. FIG. 2 shows a flow diagram of the method.

As shown in FIG. 2, when a document is opened by a document reader, the opened document is checked to see whether it comprises a marked section in step S201. The check can be performed by scanning the whole document to determine whether a mark added as described above exists in the document. When it is determined in step S201 that the document does not comprise the marked section, the method for controlling scrolling of a document according to the first embodiment of the present invention is not needed to be performed, and the process ends. On the contrary, when it is determined in step S201 that the document comprises the marked section, the process proceeds to step S202.

In step S202, checking whether the document is scrolled. As is well known in the art, when the document is scrolled, an operating system will trigger a scrolling event, thus whether the document is scrolled may be judged by detecting whether the scrolling event is triggered. If the document is not scrolled, the process returns to step S202. On the contrary, if the document is scrolled, it is detected whether the document is scrolled to the marked section in step S203. A method for detecting whether the document is scrolled to the marked section in step S203 will be described in details later.

If it is determined that the document is scrolled to the marked section in step S203, the scrolling of the document is restricted in step S204. The scrolling of the document may be restricted in a plurality of manners. In one manner for restricting the scrolling of the document, when the document is scrolled to the marked section, the scrolling of the document may be paused for a predetermined restriction time period, so that the marked section stays on the screen and thus the reader can notice the marked section. Then, the restriction on the scrolling of the document is cancelled after the predetermined restriction time period lapses, so that the document can continue to be scrolled. As described above, the predetermined restriction time period is specified by the value of the mark for indicating the marked section. In another manner for restricting the scrolling of the document, which is a preferred manner, when it is determined that the document is scrolled to the marked section, the scrolling of the document is restricted according to whether a length of the marked section exceeds a length of a display area, and then the restriction on the scrolling of the document is cancelled after the predetermined restriction time period lapses. This preferred manner for restricting the scrolling of the document will be described in details later.

Next, in step S205, determining whether the document is scrolled to an end of the document. If the document has been scrolled to the end, the process ends. On the contrary, if the document has not been scrolled to the end, the process returns to step S203 and performs subsequent steps as described above, until the document is scrolled to the end.

Hereinafter, an exemplary method for determining whether the document is scrolled to the marked section in step S203 will be described with reference to FIG. 3.

As shown in FIG. 3, when it is found in step S202 that the document is scrolled, the process proceeds to step S2031. In step S2031, a marked-section start position of the marked section relative to the beginning of the document is calculated. Since the scrolling of the document is performed in unit of lines, the calculated marked-section start position is actually a position of a line in which the beginning of the marked section is located relative to the beginning of the document (for example, line 0). As is well known, when a document is displayed within a display area, the display layout of the document will be automatically adjusted according to a size of the display area. For example, for a document having 100 characters, if a length of each line in the display area is 25 characters, the document will be displayed in 4 lines, and if the length of each line in the display area is 40 characters, the document will be displayed in 3 lines. In addition, the document (and the marked section) may comprise picture elements. In consideration of the above fact, the calculated marked-section start position is preferably represented in unit of pixels. As is commonly known in the art, when the document is displayed within the display area, the number of lines and the number of pixels of the whole document in the direction of length (height) are fixed as long as the display area is not changed, and a pixel height of each line (including a line space) of the document which is displayed within the display area is also known. Therefore, in step S2031, a start character position of the marked section relative to the beginning of the document, i.e., a position of a character at the beginning of the marked section, can be calculated according to a position of the mark indicating the marked section, the position of the line in which the beginning of the marked section is located can be determined according to the start character position and the number of characters in each line in the display area, and then the position of the line in which the beginning of the marked section is located is converted into a position represented in pixels according to the number of lines and the number of pixels of the whole document, thereby obtaining the position of the beginning of the marked section relative to the beginning of the document represented in unit of pixels, i.e., the marked-section start position. It is to be appreciated that, although the marked-section start position is preferably represented in unit of pixels here, this is not limitative; in fact, lines or other parameters can be directly used for this purpose, as long as the used parameter can reflect the position of the beginning of the marked section relative to the beginning of the document.

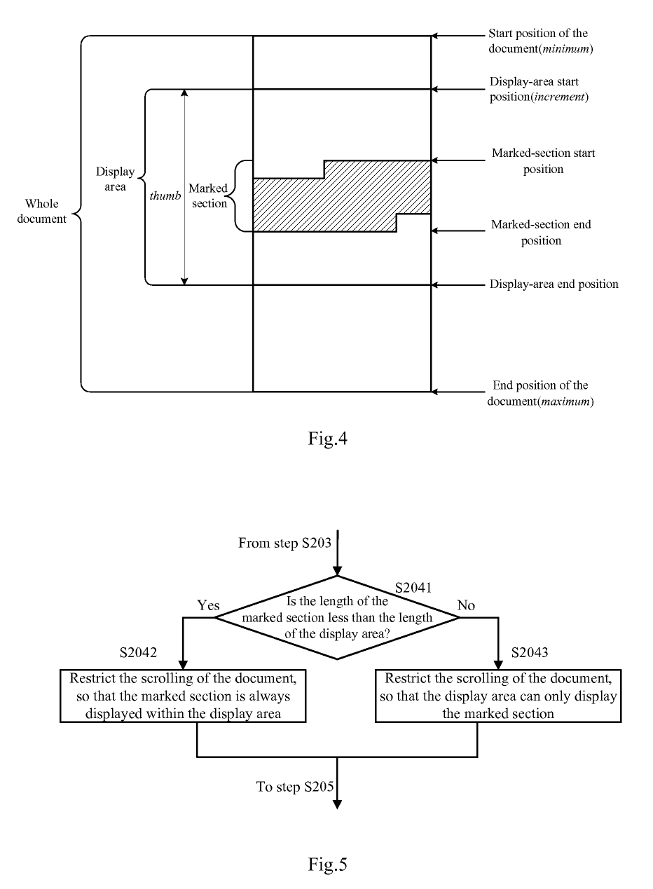

Next, a display-area start position of the display area relative to the beginning of the document is calculated in step S2032. The display-area start position is a position of a line displayed at the beginning of the display area relative to the beginning of the document (for example, line 0), and is also preferably represented by pixels. Take a Windows operating system as an example. As is commonly known in the art, when a document is scrolled, 4 variables in unit of for example lines, i.e. minimum, maximum, thumb and increment, are automatically generated in a Windows Application Programming Interface (API) to control scrolling of the document, wherein minimum represents a start position of the document, maximum represents an end position of the document, thumb represents a length of the display area, and increment represents a start position of the display area, i.e. a position of document contents displayed at the beginning of the display area. FIG. 4 schematically shows the position relationship of the document, the display area displaying the document, and the marked section in the document, and the above-described 4 variables. According to these variables, a position of a line displayed at the beginning of a current display area in the document, i.e., the display-area start position of the display area relative to the beginning of the document, can be calculated by the following equation:

the display-area start position=(increment−minimum)/(maximum−minimum)×a displayed length of the whole document in unit of pixels,

in which “increment−minimum” is a length (a number of lines) of contents of the document which have been scrolled out of the display area, “maximum−minimum” is a length (a number of lines) of the whole document, and the “displayed length of the whole document in unit of pixels” is a length in unit of pixels obtained by converting the number of lines of the whole document into the number of pixels of the whole document in the direction of length (height).

Since the display-area start position is represented by pixels in the above equation, the equation is also applicable to documents including picture elements. In addition, in other operating systems, the display-area start position can be calculated by the above equation by using similar parameters for controlling scrolling of a document in the systems.

Next, in step S2033, the marked-section start position calculated in step S2031 is compared with the display-area start position calculated in step S2032 to see whether they are identical. If they are identical, the line displayed at the beginning of the display area is the line in which the beginning of the marked section is located, thus the document has been scrolled to the marked section, and the process proceeds to step S204. On the contrary, if they are not identical, the line displayed at the beginning of the display area is not the line in which the beginning of the marked section is located, thus the document has not been scrolled to the marked section, and the process proceeds to the step S205.

Hereinafter, the above-described preferred manner for restricting the scrolling of the document in step S204 will be described with reference to FIG. 5. As shown in FIG. 5, when it is determined in step S203 that the document is scrolled to the marked section, it is judged in step S2041 whether the length of the marked section is less than the length of the display area displaying the document. Preferably, the length of the marked section is represented by the number of pixels of the marked section in the direction of length (i.e., height) (from a first line to a last line), and the length of the display area is represented by the number of pixels of the display area in the direction of length (i.e., height) (from a first line to a last line). For example, the length of the marked section can be obtained by converting the number of lines occupied by the marked section into length (i.e., height) represented by pixels, and the length (i.e., the height) of the display area can be obtained by the above-described variable thumb. Then, the relationship between the two lengths can be determined by comparing them.

If the length of the marked section is less than the length of the display area, in step S2042, the scrolling of the document is restricted so that the marked section is always displayed within the display area. In particular, the scrolling of the document is restricted, so that the user may continue to scroll the document, but the scrolling operation performed by the user will be prohibited if the scrolling operation is going to make a part of or the whole marked section leave the display area. For example, this can be implemented by calculating the marked-section start position as described above, and calculating a marked-section end position; calculating a start position and an end position of the display area relative to the beginning of the document; detecting whether the display-area start position is the same as the marked-section start position, and prohibiting the operation of continuing to scroll down the document by the user (the operation will make the beginning of the marked section leave the display area) if they are the same; and detecting whether the display-area end position is the same as the marked-section end position, and prohibiting the operation of continuing to scroll up the document by the user (the operation will make the end of the marked section leave the display area) if they are the same. The marked-section end position can be obtained by adding the length of the marked section to the marked-section start position. The display-area end position can be obtained by converting the length of the display area represented by thumb to a length in unit of pixels and then adding the length to the display-area start position.

On the contrary, if the length of the marked section is larger than or equal to the length of the display area, the scrolling of the document is restricted in step S2043 so that the display area can only display the marked section. Specifically, the scrolling of the document is restricted, so that the user can continue to scroll the document, but if the scrolling operation performed by the user will make contents other than the marked section appear in the display area, the scrolling operation will be prohibited. This can be implemented by calculating the marked-section start position and the marked-section end position; calculating the start position and the end position of the display area relative to the beginning of the document; detecting whether the display-area start position is the same as the marked-section start position, and prohibiting the operation of continuing to scroll up the document by the user (the operation will make contents before the marked section appear within the display area) if they are the same; and detecting whether the display-area end position is the same as the marked-section end position, and prohibiting the operation of continuing to scroll down the document by the user (the operation will make contents after the marked section appear within the display area) if they are the same.

Hereinbefore, the method for controlling scrolling of a document according to the first embodiment of the present invention is described with reference to FIG. 2. It is to be appreciated that the flow shown in FIG. 2 is illustrative, rather than limitative, and appropriate modifications can be made thereto to obtain various variants. For example, although in the flow shown in FIG. 2, it is firstly checked whether the whole document comprises the marked section in step S201 after the document is opened, this step may be not performed; instead, it is checked whether a mark indicating the marked section is encountered while the document is being scrolled, so as to determine whether the document comprises the marked section. Further, the executing orders of step S201 and step S202 can be interchanged. Furthermore, when the document is scrolled to the marked section, the marked section can be highlighted, besides restricting the scrolling of the document, so that the marked section can be noticed more easily.

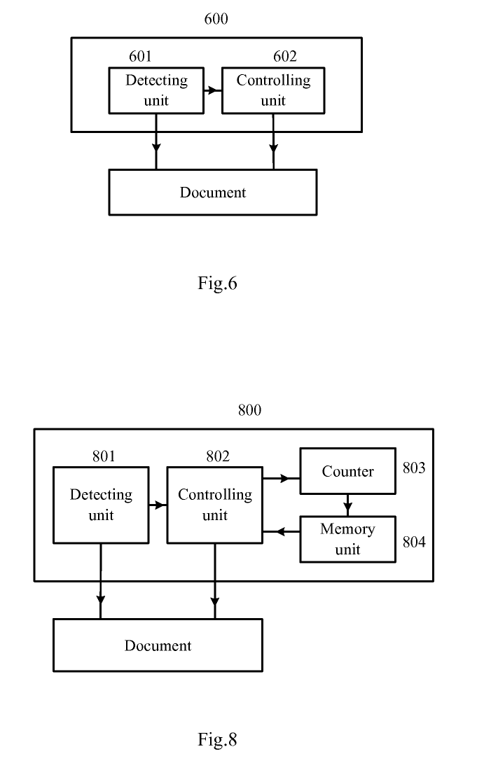

Hereinafter, a device for controlling scrolling of a document according to the first embodiment of the present invention will be described with reference to FIG. 6. As shown in FIG. 6, the device 600 for controlling scrolling of a document according to the first embodiment of the present invention comprises a detecting unit 601 and a controlling unit 602.

When a document is opened, the device 600 is started. The detecting unit 601 checks whether the opened document comprises a marked section. The detecting unit 601 can perform the check by scanning the whole document to determine whether a mark added as described above exists in the document. If the document does not comprise the marked section, the device 600 does not perform a scrolling restriction operation on the document.

When the document comprises the marked section, the detecting unit 601 judges whether the document is scrolled. For example, the detecting unit 601 can judge whether the document is scrolled by detecting whether the above-described scrolling event is triggered. When the document is scrolled, the detecting unit 601 detects whether the document is scrolled to the marked section. The detecting unit 601 can detect whether the document is scrolled to the marked section in the manner described above with respect to FIG. 3, that is, the detecting unit 601 calculates the marked-section start position of the marked section relative to the beginning of the document and the display-area start position of the display area relative to the beginning of the document, and checks whether the marked-section start position is the same as the display-area start position so as to determine whether the document is scrolled to the marked section, wherein when the two are the same, the detecting unit 601 determines that the document is scrolled to the marked section.

The detecting unit 601 notifies a result of the detection to the controlling unit 602. When the result of the detection indicates that the document is not scrolled to the marked section, the controlling unit 602 does not intervene in the scrolling of the document. On the other hand, when the result of the detection indicates that the document is scrolled to the marked section, the controlling unit 602 restricts the scrolling of the document, so that the marked section will be not neglected due to quick scrolling of the document.

The controlling unit 602 may restrict the scrolling of the document in many manners. As described above, in one manner, when it is determined that the document is scrolled to the marked section, the controlling unit 602 can pause the scrolling of the document for a predetermined restriction time period, so that the marked section stays on the screen and thus the reader can notice the marked section, and then cancel the restriction on the scrolling of the document after the predetermined restriction time period lapses, so that the document can continue to be scrolled. The predetermined restriction time period is set by the creator or the reader of the document by setting the value of the mark for indicating the marked section.

In addition, the controlling unit 602 can restrict the scrolling of the document in the preferred manner as described above; that is, when it is determined that the document is scrolled to the marked section, the controlling unit 602 restricts the scrolling of the document according to whether the length of the marked section exceeds the length of the display area, and then cancels the restriction on the scrolling of the document after the predetermined restriction time period lapses. Specifically, when it is determined that the document is scrolled to the marked section, the controlling unit 602 detects whether the length of the marked section is less than the length of the display area according to the method described above with respect to FIG. 5. When the detected result indicates that the length of the marked section is less than the length of the display area, the controlling unit 602 restricts the scrolling of the document, so that the marked section is always displayed within the display area. That is, the user can continue to scroll the document, but if the scrolling operation performed by the user will make a part of or the whole marked section leave the display area, the scrolling operation will be prohibited. This can be implemented in the manner described above with respect to step S2042 in FIG. 5. On the contrary, if the length of the marked section is larger than or equal to the length of the display area, the controlling unit 602 restricts the scrolling of the document, so that the display area can only display the marked section; that is, the user can continue to scroll the document, but if the scrolling operation performed by the user will make contents other than the marked section appear in the display area, the scrolling operation will be prohibited. This can be implemented in the manner described above with respect to step S2043 in FIG. 5.

When the document is scrolled to the marked section, the controlling unit 602 can highlight the marked section, besides the above restriction operation, so as to enable the marked section to be easily noticed. For example, the marked section can be highlighted by changing colour, font, and/or other parameters of the marked section.

It can be seen that, desired contents in a document can be avoided from being neglected due to quick scrolling of the document by marking the desired contents to generate a marked section and restricting the scrolling of the document when the document is scrolled to the marked section. In addition, a user can locate the desired contents more easily by highlighting the marked section.

In the method and device according to the first embodiment of the present invention, scrolling of a document is restricted for a predetermined restriction time period each time the document is scrolled to a marked section. However, during reading the document, the user often scrolls the document forward and backward. In such a situation, if the scrolling of the document is restricted for the predetermined period each time the document is scrolled to a marked section containing contents which are not very important, the user will feel inconvenient, and this is also unnecessary. To this end, different restriction modes can be set for respective marked sections. Correspondingly, the scrolling of the document can be controlled based on the restriction modes set for the marked sections.

Specifically, three restriction modes, i.e. a first restriction mode, a second restriction mode, and a third restriction mode, can be provided. In the first restriction mode, each time the document is scrolled to the marked section, the scrolling of the document is restricted for a first predetermined restriction time period. In the second restriction mode, the scrolling of the document is restricted for the first predetermined restriction time period when a number of times for which the document is scrolled to the marked section is less than or equal to a threshold value, and the scrolling of the document is restricted for a second predetermined restriction time period when the number of times for which the document is scrolled to the marked section is larger than the threshold value. In the third restriction mode, each time the document is scrolled to the marked section, the scrolling of the document is restricted for the second predetermined restriction time period. The second predetermined restriction time period is preferably less than the first predetermined restriction time period. For example, the first restriction mode may be a high restriction mode, the second restriction mode may be a normal restriction mode, and the third restriction mode may be a low restriction mode. If a marked section is set to the low restriction mode, the scrolling of the document is restricted for the second predetermined restriction time period (for example, a short time period which is set additionally) each time the document is scrolled to the marked section, irrespectively of the restriction time period preset for the marked section by the value of the mark (i.e. the first predetermined restriction time period). The short time period is preferably less than the restriction time period preset for the marked section, and is preferably less than 1 second, for example, 0.5 second. If a marked section is set to the high restriction mode, the scrolling of the document is restricted for the restriction time period preset for the marked section (i.e. the first predetermined restriction time period) each time the document is scrolled to the marked section. If a marked section is set to the normal restriction mode, the scrolling of the document is restricted for the restriction time period preset for the marked section (i.e., the first predetermined restriction time period) when the number of times for which the document is scrolled to the marked section is less than or equal to the threshold value, and the scrolling of the document is restricted for the second predetermined restriction time period (for example, the short time period which is set additionally) when the number of times for which the document is scrolled to the marked section is larger than the threshold value.

The restriction mode of the marked section can be set by the creator and the reader of the document together, and an example of the setting manner is given below.

On the creator side, when the document is created, besides adding a mark such as the attribute “section” onto desired contents to generate a marked section and specifying the restriction time period by a value of the mark as described above, a “mode” attribute associated with the marked section can be additionally added, and the restriction mode of the marked section can be specified by a value of the attribute. For example, the low restriction mode, the normal restriction mode, and the high restriction mode can be indicated by the values of the “mode” attribute, “0”, “1”, and “2”, respectively. In the case of the normal restriction mode, the threshold value can be set by adding an additional parameter for the number of times or set in other manners. In addition, the creator may assign an ID to the marked section so as to facilitate counting the number of times for which the document is scrolled to the marked section.

On the reader side, the whole document can be set to the low restriction mode, the normal restriction mode, or the high restriction mode. For example, the reader can perform this setting by means of a plug-in installed in a document reader. When the document is opened by the document reader, the plug-in is activated, and a dialogue box which prompts the user to select the restriction mode of the document is popped up so as to enable the user to set the restriction mode of the document.

A final restriction mode of each marked section in the document is determined according to the restriction mode set for the marked section by the creator and the restriction mode set for the whole document by the reader. For example, the final restriction mode of each marked section can be determined according to the following Table 1.

TABLE 1
The final restriction mode for the marked section

| | Creator | | |
|---|---|---|---|
| Reader | High restriction mode | Normal restriction mode | Low restriction mode |
| High restriction mode | High restriction mode | High restriction mode | High restriction mode |
| Normal restriction mode | High restriction mode | Normal restriction mode | Normal restriction mode |
| Low restriction mode | High restriction mode | Normal restriction mode | Low restriction mode |

The restriction mode of the marked section can also be set solely by the creator of the document. In such a situation, the restriction mode set by the creator can be directly used as the final restriction mode. Alternatively, the user may set solely the restriction mode for each marked section in the document or for the whole document in the same manner as the creator does. In addition, although it is mentioned above that an ID is assigned to each marked section by the creator, the ID can be assigned by the reader, or temporally generated for each marked section by the document reader when the document is opened by the document reader.

For a document including marked sections created in the above manner, a method and device for controlling scrolling of a document according to a second embodiment of the present invention can control the scrolling of the document according to a restriction mode of each of the marked sections.

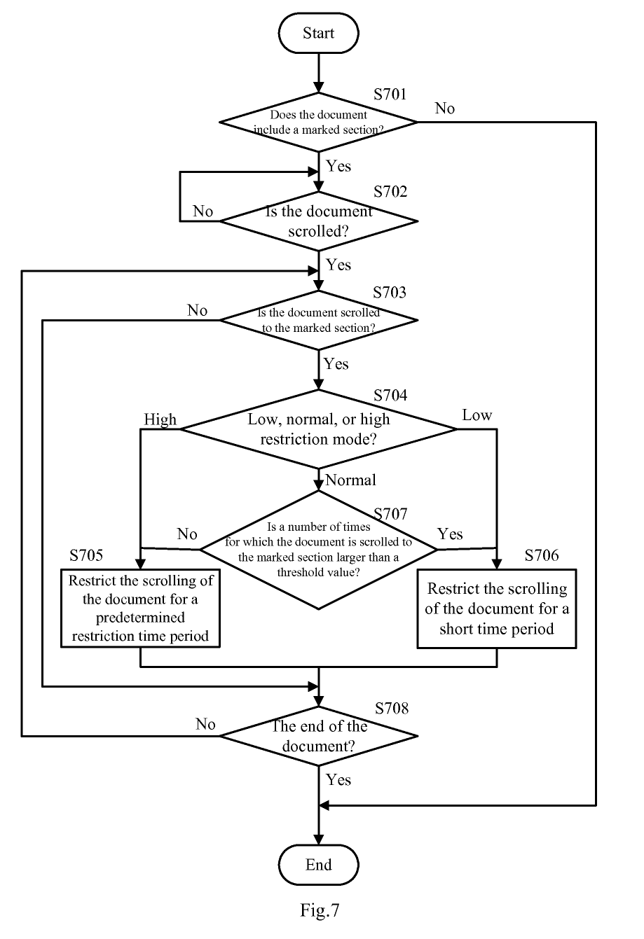

The method for controlling scrolling of a document according to the second embodiment of the present invention is described below with reference to FIG. 7. Steps S701 to S703 shown in FIG. 7 are respectively the same as steps S201 to S203 in the method according to the first embodiment of the present invention shown in FIG. 2, thus the descriptions of the same steps are omitted for simplicity.

When it is determined in step S703 that the document is not scrolled to the marked section, the process proceeds to step S708, and the same operations as described above are performed. When it is determined in step S703 that the document is scrolled to the marked section, in step S704, it is determined whether the restriction mode of the marked section is the low restriction mode, the normal restriction mode, or the high restriction. In the case where the restriction mode is set by the creator and the reader together, the restriction mode of the marked section may be determined according to Table 1 by examining the restriction modes set respectively by the creator and the reader. In the case where the restriction mode is solely set by the creator or the reader, it is only necessary to examine the restriction mode set by the creator or the reader.

When the marked section is set to the high restriction mode, the scrolling of the document is restricted for the restriction time period preset for the marked section in step S705.

When the marked section is set to the low restriction mode, the scrolling of the document is restricted for a short time period in step S706, irrespectively of the restriction time period preset for the marked section. The short time period can be preset by the creator or the reader by editing a script file of the document or through a plug-in in the document reader, and is preferably less than the restriction time period preset for the marked section. In addition, the short time period is preferably less than 1 second, for example, 0.5 second.

When the marked section is set to the normal restriction mode, it is determined in step S707 whether a number of times for which the document is scrolled to the marked section is larger than a threshold value. When the number of times is less than or equal to the threshold value, the process proceeds to step S705, in which the scrolling of the document is restricted for the predetermined restriction time period set for the marked section. When the number of times is larger than the threshold value, the process proceeds to the step S706, in which the scrolling of the document is restricted for the short time period irrespectively of the predetermined restriction time period. To obtain the number of times for which the document is scrolled to the marked section which is set to the normal restriction mode, the number of times for which the document is scrolled to the marked section can be counted using a counter, and the count value is stored in a memory in association with an ID of the marked section, wherein the count value is increased by 1 each time the document is scrolled to the marked section which is set to the normal restriction mode. Therefore, in step S707, the number of times can be obtained by reading the associated count value from the memory according to the ID of the marked section.

The scrolling of the document can be restricted in a plurality of manners in steps S705 to S707, as in the first embodiment. As described above, the scrolling of the document can be paused for a respective restriction time period, and then the restriction on the scrolling of the document is cancelled after the restriction time period lapses. Alternatively, the scrolling of the document can be restricted in the preferred manner as described above; that is, when it is determined that the document is scrolled to the marked section, the scrolling of the document is restricted according to whether the length of the marked section exceeds the length of the display area, and the restriction on the scrolling of the document is cancelled after the respective restriction time period lapses. However, according to the restriction mode of the marked section (and the number of times for which the document is scrolled to the marked section), the restriction time period herein is correspondingly the predetermined restriction time period set for the marked section or the short time period.

After finishing performing step S705 or step S706, it is determined in step S708 whether the document is scrolled to the end of the document. If the document is scrolled to the end, the process ends. On the contrary, if the document is not scrolled to the end of the document, the process returns to the step S703, and subsequent steps are performed, until the document is scrolled to the end.

A device for controlling scrolling of a document according to the second embodiment of the present invention is described below with reference to FIG. 8. As shown in FIG. 8, the device 800 for controlling scrolling of a document according to the second embodiment of the present invention comprises a detecting unit 801, a controlling unit 802, a counter 803, and a memory unit 804.

When the document is opened, the device 800 is started. The detecting unit 801 detects whether a marked section exists in the opened document, whether the document is scrolled, and whether the document is scrolled to the marked section in the same manner as the detecting unit 601 does. When the detecting unit 801 detects that the document is scrolled to the marked section, it further detects a restriction mode of the marked section. The controlling unit 802 restricts the scrolling of the document according to the detected restriction mode.

In the case where the restriction mode is set by the creator and the reader together, the detecting unit 801 can examine the restriction mode set for the marked section by the creator and the restriction mode set for the whole document by the reader, and then determines the final restriction mode of the marked section according to the above Table 1. In the case where the restriction mode is set solely by the creator or the reader, the detecting unit 801 can examine the restriction mode set by the creator or the reader, and determine the restriction mode as the final restriction mode of the marked section.

The counter 803 counts a number of times for which the document is scrolled to a marked section which is set to the normal restriction mode, and stores the count value in the memory unit 804 in association with an ID of the marked section, wherein the detecting unit 801 increases the corresponding count value stored in the memory unit 804 by 1 each time it detects that the document is scrolled to the marked section which is set to the normal restriction mode.

Operations of the controlling unit 802 will be described in details below.

The detecting unit 801 detects whether the document is scrolled to the marked section, and notifies a result of the detection to the controlling unit 802. When the document is not scrolled to the marked section, the controlling unit 802 does not intervene in the scrolling of the document. On the other hand, when the document is scrolled to the marked section, the controlling unit 802 instructs the detecting unit 801 to determine the restriction mode of the marked section. The detecting unit 801 determines whether the restriction mode of the marked section is the low restriction mode, the normal restriction mode, or the high restriction mode in the manner described above, and notifies a result of the determination to the controlling unit 802.

When the marked section is set to the high restriction mode, the controlling unit 802 restricts the scrolling of the document for the restriction time period preset for the marked section. The controlling unit 803 can obtain the restriction time period by examining a value of a mark for indicating the marked section.

When the marked section is set to the low restriction mode, the controlling unit restricts the scrolling of the document for the short time period described above, irrespectively of the restriction time period preset for the marked section.

When the marked section is set to the normal restriction mode, the controlling unit 802 judges whether the number of times for which the document is scrolled to the marked section is larger than the threshold value. When the number of times is less than or equal to the threshold value, the controlling unit 802 restricts the scrolling of the document for the predetermined restriction time period set for the marked section. When the number of time is larger than the threshold value, the controlling unit 802 restricts the scrolling of the document for the short time period, irrespectively of the preset restriction time period. The controlling unit 802 can obtain the number of times for which the document is scrolled to the marked section by reading the associated count value from the memory unit 804 according to the ID of the marked section.

Besides the above restriction operation, the controlling unit 802 can highlight the marked section. In addition, the controlling unit 802 can apply the restriction on the scrolling of the document in the plurality of manners as described above, wherein according to the restriction mode of the marked section (and the number of times for which the document is scrolled to the marked section), the time period during which the scrolling of the document is restricted is correspondingly the restriction time period preset for the marked section or the short time period described above. The description thereof is omitted here to avoid repetition.

The device for controlling scrolling of a document according to the embodiments of the present invention is described hereinbefore. It is to be appreciated that the device can be implemented in various forms, including hardware, software, or a combination thereof, and the device can be implemented independently from the document reader, or can be integrated into the document reader in form of, for example, a plug-in.

It can be seen that, unlike the conventional art that a user can scroll a document freely without any limitation, the method and device for controlling scrolling of a document according to the embodiments of the present invention control the scrolling of the document based on contents of the document, so that for some desired contents in the document, the user cannot intentionally or unconsciously skip over or neglect them by scrolling the document.

Alternative embodiments of the present invention may further include computer readable codes on a computer readable medium. The computer readable codes can, when executed, perform the method for controlling scrolling of a document. The computer readable medium may include a computer readable recording medium and a computer readable transmission medium. The computer readable recording medium is any data storage apparatus that can store data which can be read by a computer system subsequently. Examples of the computer readable recording medium include a magnetic storage medium, such as a read-only memory (ROM), a random access memory (RAM), a CD-ROM, a magnetic tape, a floppy disk, and a hard disk, and an optical storage apparatus, such as a CD (compact disk) and a DVD (digital versatile disk). The computer readable recording medium may also be distributed on network-coupled computer systems so that the computer readable codes are stored and executed in a distributed way. The computer readable transmission medium can transmit a carrier or a signal (for example, a wired or wireless data transmission via the Internet). In addition, programmers in the art to which the present invention pertains can easily construe a functional program, codes and code segments for implementing the present invention.

Although the exemplary embodiments of the present invention have been shown and described, it is to be understood by those skilled in the art that various changes in form and details can be made to these exemplary embodiments without departing from the scope and spirit of the present invention as defined in the claims and equivalents thereof.

1. A method for controlling scrolling of a document comprising:
detecting whether a document loaded for viewing in a display area of a document reader executing in memory of a computer system has scrolled to a marked section of the document, and
restricting in the document reader the scrolling of the document when the document has scrolled to the marked section.

2. The method according to claim 1, wherein the detecting step comprises:
calculating a marked-section start position of the marked section relative to a beginning of the document;
calculating a display-area start position of the display area relative to the beginning of the document; and
determining whether the document is scrolled to the marked section by checking whether the marked-section start position and the display-area start position are the same,
wherein it is determined that the document is scrolled to the marked section when the marked-section start position and the display-area start position are the same.

3. The method according to claim 1, wherein the restricting step comprises:
pausing the scrolling of the document.

4. The method according to claim 1, wherein the restricting step comprises:
judging whether a length of the marked section is less than a length of the display area; and
restricting the scrolling of the document so that the marked section is always displayed within the display area when the length of the marked section is less than the length of the display area, and restricting the scrolling of the document so that the display area can only display the marked section when the length of the marked section is larger than the length of the display area.

5. The method according to claim 1, wherein the marked section is provided with a corresponding predetermined restriction time period, and wherein in the restricting step, the scrolling of the document is restricted in the predetermined restriction time period, and the restriction on the scrolling of the document is cancelled after the predetermined restriction time period lapses.

6. The method according to claim 1, wherein the marked section is provided with a corresponding first predetermined restriction time period and a restriction mode, and wherein the restricting step comprises the following steps:
detecting the restriction mode of the marked section; and
restricting the scrolling of the document according to the detected restriction mode.

7. The method according to claim 6, wherein in the restricting step,
if the detected restriction mode is a first restriction mode, the scrolling of the document is restricted for the first predetermined restriction time period each time the document is scrolled to the marked section;
if the detected restriction mode is a second restriction mode, the scrolling of the document is restricted for the first predetermined restriction time period when a number of time for which the document is scrolled to the marked section is less than or equal to a threshold value, and the scrolling of the document is restricted for a second predetermined restriction time period when the number of time for which the document is scrolled to the marked section is larger than the threshold value; and
if the detected restriction mode is a third restriction mode, the scrolling of the document is restricted for the second predetermined restriction time period each time the document is scrolled to the marked section.

8. The method according to claim 7, wherein the second predetermined restriction time period is less than the first predetermined restriction time period.

9. The method according to claim 1, wherein the marked section is further highlighted in the restricting step.

10. A scroll control device comprising:
a computer system with processor and memory;
a detecting unit executing in the memory of the computer system for detecting whether a document displayed in a display area of a document reader has scrolled to a marked section of the document, and
a controlling unit executing in the memory of the computer system for restricting the scrolling of the document when the document is scrolled to the marked section.

11. The device according to claim 10, wherein when performing the detecting, the detecting unit calculates a marked-section start position of the marked section relative to a beginning of the document and a display-area start position of the display area relative to the beginning of the document, and checks whether the marked-section start position and the display-area start position are the same to determine whether the document is scrolled to the marked section,
wherein the detecting unit determines that the document is scrolled to the marked section when the marked-section start position and the display-area start position are the same.

12. The device according to claim 10, wherein the controlling unit performs the restriction by pausing the scrolling of the document.

13. The device according to claim 10, wherein when restricting the scrolling of the document, the controlling unit judges whether a length of the marked section is less than a length of the display area, restricts the scrolling of the document so that the marked section is always displayed within the display area when the length of the marked section is less than the length of the display area, and restricts the scrolling of the document so that the display area can only display the marked section when the length of the marked section is larger than the length of the display area.

14. The device according to claim 10, wherein the marked section is provided with a corresponding predetermined restriction time period, and wherein when restricting the scrolling of the document, the controlling unit restricts the scrolling of the document for the predetermined restriction time period, and cancels the restriction on the scrolling of the document after the predetermined restriction time period lapses.

15. The device according to claim 10, wherein the marked section is provided with a corresponding first predetermined restriction time period and a restriction mode, and wherein
when restricting the scrolling of the document, the detecting unit detects the restriction mode of the marked section, and the controlling unit restricts the scrolling of the document according to the restriction mode detected by the detecting unit.

16. The device according to claim 15, wherein
if the detected restriction mode is a first restriction mode, the controlling unit restricts the scrolling of the document for the first predetermined restriction time period each time the document is scrolled to the marked section;
if the detected restriction mode is a second restriction mode, the controlling unit restricts the scrolling of the document for the first predetermined restriction time period when a number of time for which the document is scrolled to the marked section is less than or equal to a threshold value, and the controlling unit restricts the scrolling of the document for a second predetermined restriction time period when the number of time for which the document is scrolled to the marked section is larger than the threshold value; and
if the detected restriction mode is a third restriction mode, the controlling unit restricts the scrolling of the document within the second predetermined restriction time period each time the document is scrolled to the marked section.

17. The device according to claim 16, wherein the second predetermined restriction time period is less than the first predetermined restriction time period.

18. The device according to claim 10, wherein the controlling unit further highlights the marked section when restricting the scrolling of the document.
